(19) United States
(12) Patent Application Publication
(10) Pub. No.: US 2013/0297969 A1
(43) Pub. Date: Nov. 7, 2013

(54) FILE MANAGEMENT METHOD AND APPARATUS FOR HYBRID STORAGE SYSTEM

(71) Applicant: ELECTRONICS AND TELECOMMUNICATIONS RESEARCH INSTITUTE, Daejeon-city (KR)

(72) Inventors: Young-Chang KIM, Daejeon (KR); Hong-Yeon KIM, Daejeon (KR); Wan CHOI, Daejeon (KR)

(73) Assignee: ELECTRONICS AND TELECOMMUNICATIONS RESEARCH INSTITUTE, Daejeon-city (KR)

(21) Appl. No.: 13/864,685

(22) Filed: Apr. 17, 2013

(30) Foreign Application Priority Data
May 4, 2012 (KR) 10-2012-0047400

(51) Int. Cl. G06F 17/30; G06F 11/14

(52) U.S. Cl. CPC G06F 17/30215; G06F 11/1412
USPC 714/15; 707/823

(57) ABSTRACT

The present invention relates to a method of improving file write performance and providing availability in a hybrid storage system. When a file writing target server information request signal is received from a client, any one cache server is selected in consideration of storage spaces of cache servers, information about the selected cache server to the client is transmitted so that the client stores the file in the selected cache server. When a duplicate writing target server information request is received from the selected cache server, any one first data server is selected in consideration of storage spaces of respective data servers, information about the selected first data server is transmitted to the cache server so that the cache server stores a duplicate of the file in the first data server. Information about storage of the file and the duplicate is received, and then file metadata is stored.

### CROSS REFERENCE TO RELATED APPLICATION

This application claims the benefit of Korean Patent Application No. 10-2012-0047400, filed on May 4, 2012, which is hereby incorporated by reference in its entirety into this application.

### BACKGROUND OF THE INVENTION

1. Technical Field

The present invention relates generally to a method of improving file write performance and providing availability in a hybrid storage system and, more particularly, to a method and apparatus that can improve file write performance by using a high-speed storage device as a cache server for file storage and that can provide availability for file management by storing a plurality of duplicates of a file in different data servers using real-time duplication and delayed duplication of the file, in a hybrid storage system composed of a high-performance storage device, such as a Solid State Drive (SSD), and a normal Hard Disk Drive (HDD).

2. Description of the Related Art

A Solid State Drive (SSD) is a semiconductor-based storage device. An SSD is advantageous in that sequential read/write performance and the throughput of random read/write instructions are better than those of a Hard Disk Drive (HDD) and the power consumption is lower than that of an HDD. However, such an SSD is disadvantageous in that it is difficult to use the SSD as a main storage device because of the fact that when a portion in which storage is to be performed belongs to a region that was not deleted, deletion must be performed first, the fact that a storage space for a given price is smaller than that of an HDD, so that when a large-capacity storage system is constructed, cost is increased, and the fact that the lifespan of the SSD is shorter than that of an HDD and then the stability of the SSD is so low that the SSD cannot be used for an enterprise-level storage server.

Therefore, in order to make up for the disadvantages of the two storage devices and utilize the advantages thereof, the development of a technology related to a hybrid storage system that can utilize together the two storage devices and can use the SSD as a cache for the HDD, rather than as a main storage device, has been required.

Based on these efforts, U.S. Patent Application Publication No. 2011-0153931 A1 discloses “Hybrid storage subsystem with mixed placement of file contents.” This technology discloses research into a method of using an SSD as a read cache in a storage sub-system in which the SSD and an HDD are configured together. That is, if a file block is not present in the SSD when a file is accessed, the corresponding file block is accessed via the HDD. However, the file block that was accessed once is transferred from the HDD to the SSD and is stored in the SSD, so that the SSD is used as a read cache so as to improve the speed at which the same file block is subsequently accessed. File update is performed by both the SSD and the HDD in which the file is stored, but the initial generation of the file is always performed by the HDD. However, this technology is disadvantageous in that when random access to the file occurs frequently, and when contents of the accessed file are located in different blocks, a cache miss frequently occurs even if the same file is accessed, thus deteriorating cache efficiency, and in that when a large-capacity file, such as a video file, is continuously accessed once, the advantage of cache usage is decreased.

Further, this technology is problematic in that when blocks that have been transferred from the HDD and cached in the SSD are lost, there is no alternative solution to deal with such a loss.

Meanwhile, Korean Patent Application Publication No. 10-2008-0090959 discloses “Storage device, method, and computer-readable recording medium for improving random write performance on SSD.” This technology is characterized in that in order to improve the random write performance of the SSD which is relatively low compared to the sequential read/write performance, the throughput of random read/write instructions, and random read performance, a hard disk drive is used as the cache of the SSD for random writing, so that the advantage of the SSD is provided in a read operation, and the advantage of the HDD is maintained for write operations. However, this technology is problematic in that there is no alternative solution to deal with the loss of data that may occur because stability is deteriorated due to the short lifespan of the SSD.

### SUMMARY OF THE INVENTION

Accordingly, the present invention has been made keeping in mind the above problems occurring in the prior art, and an object of the present invention is to improve the write performance of a file by utilizing a server, implemented as a high-speed storage device, as a cache server for file storage, and to provide availability by maintaining three file duplicates by means of real-time duplication from a cache server to a normal data server and by means of delayed duplication from a data server to another data server.

In accordance with an aspect of the present invention to accomplish the above object, there is a provided a file management method using a metadata server of a hybrid storage management system, including when a request for information about a target server in which a file is to be written is received from a client, selecting any one cache server in consideration of storage spaces of respective cache servers based on previously stored cache server information, transmitting information about the selected cache server to the client so that the client stores the file in the selected cache server, when a signal requesting information about a target server in which a duplicate of the stored file is to be written is received from the selected cache server, selecting any one first data server in consideration of storage spaces of respective data servers based on previously stored data server information, transmitting information about the selected first data server to the cache server so that the cache server stores a duplicate of the file in the selected first data server, and receiving information about storage of the file and the duplicate from the selected cache server and the selected first data server, and then storing file metadata.

In accordance with another aspect of the present invention to accomplish the above object, there is a provided a metadata server for a hybrid storage management system, including a cache server control unit for, when a request for information about a target server in which a file is to be written is received from a client, selecting any one cache server in consideration of storage spaces of respective cache servers based on previously stored cache server information, a network interface unit for transmitting information about the selected cache server to the client, thus allowing the client to store the file in the selected cache server, a data server control unit for, when a request for information about a target server in which a duplicate of the stored file is to be written is received from the selected cache server, selecting any one first data server in consideration of remaining storage spaces of respective data servers based on previously stored data server information, and transmitting information about the selected first data server to the cache server so that the cache server stores a duplicate of the file in the selected first data server, and a metadata control unit for receiving information about storage of the file and the duplicate from the selected cache server and the selected first data server, and then storing file metadata.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a hybrid storage system according to an embodiment of the present invention;

FIG. 2 is a diagram showing the configuration of a metadata server according to an embodiment of the present invention;

FIG. 3 is a diagram showing the configuration of a cache server according to an embodiment of the present invention;

FIG. 4 is a flowchart showing the flow of a file management method using the metadata server according to an embodiment of the present invention;

FIG. 5 is a flowchart showing in detail the file management method of FIG. 4;

FIG. 6 is a flowchart showing the flow of a file management method using the cache server according to an embodiment of the present invention;

FIG. 7 is a flowchart showing in detail the file management method of FIG. 6;

FIG. 8 is a flowchart showing the flow of a file search method using the metadata server according to an embodiment of the present invention;

FIG. 9 is a flowchart showing in detail the file search method of FIG. 8; and

FIG. 10 is a flowchart showing the flow of a file duplication method using the metadata server according to an embodiment of the present invention.

### DESCRIPTION OF THE PREFERRED EMBODIMENTS

Hereinafter, various embodiments of the present invention will be described in detail with reference to the attached drawings. Further, the terms “unit”, “module”, and “device” related to components used in the following description are merely assigned for the sake of the simplicity of description of the present specification and may be used together and designed using hardware or software.

Furthermore, embodiments of the present invention will be described in detail with reference to the attached drawings and contents described in the drawings. However, the present invention is not restricted or limited by those embodiments.

A hybrid storage system to accomplish the object of the present invention includes clients, a metadata server, cache servers, and data servers, which may be connected to one another over a network. Each cache server is a server equipped with a high-speed storage device such as a Solid State Drive (SSD), and each data server is a server equipped with a normal Hard Disk Drive (HDD). The present invention provides a method that improves write performance by using a cache server equipped with a high-speed storage device as a file writing cache server, and a method that provides availability by maintaining three file duplicates by means of real-time duplication from a cache server to a data server and delayed duplication from the data server to another data server when storing the file.

Hereinafter, embodiments of the present invention that can be easily implemented by those skilled in the art will be described in detail with reference to the attached drawings.

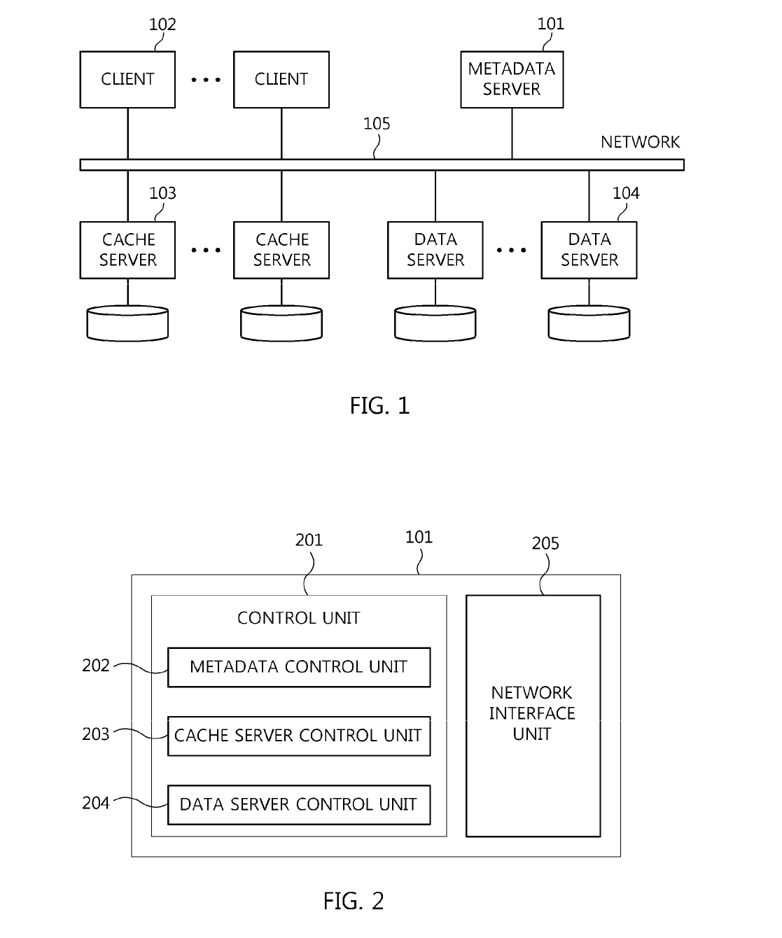

FIG. 1 is a diagram showing the configuration of a hybrid storage system according to an embodiment of the present invention.

In accordance with the embodiment, the hybrid storage system may include clients 102, a metadata server 101, cache servers 103, and data servers 104.

Each client 102 may process applications related to files. Therefore, in order to perform a task on a file, the client 102 transmits a request signal to the metadata server 101 and then obtains address information about a server which will perform the corresponding task. When the file is written, the metadata server 101 selects any one of registered cache servers 103, transfers address information about the cache server to the client 102, and the client writes the file in the corresponding cache server 103. The cache server 103 performs real-time duplication to the data server 104, together with the writing of the file, and transfers information about the duplicated file to the client once file writing and duplication have been completed. Further, after the file writing and duplication have been completed, secondary duplication is performed by duplicating the duplicate of the data server 104 to another data server 104.

Therefore, when the high-speed storage device such as an SSD is used as the cache server 103 in the hybrid storage system to which the present invention is applied, the write response speed is higher than that when using the data server 104, so that file writing is performed by the cache server 103, thus improving write performance. Further, three duplicates are maintained by means of real-time duplication from the cache server 103 to the data server 104 and delayed duplication from the data server 104 to another data server 104, thus enabling the availability of the file to be provided.

FIG. 2 is a diagram showing the configuration of the metadata server according to an embodiment of the present invention.

In accordance with the embodiment, the metadata server 101 may include a control unit 201 and a network interface unit 205, and the control unit 201 may include a metadata control unit 202, a cache server control unit 203, and a data server control unit 204.

The metadata control unit 202 manages metadata information about files. The metadata information about files includes information about the name, size, generation date, recent update date, and authority of each file, and information about a cache server and a data server that actually store each file.

Further, the metadata information about each file is generated when the file is initially generated, and can be updated when the change of the file occurs, or when a data server storing the file is changed according to the transfer of the duplicate of the file.

The cache server control unit 203 manages information about cache servers registered in the hybrid storage system. The cache server information includes information about the identifier, address, storage capacity, remaining space, etc. of each cache server. The cache server information is generated when a new cache server is registered, and is updated when the capacity information or address of a relevant cache server is changed.

In accordance with the embodiment, when a signal for requesting information about a target server in which the file is to be written is received from a client, the cache server control unit 203 can select any one cache server in consideration of the remaining storage spaces of the respective cache servers based on the previously stored cache server information.

The network interface unit 205 can transmit information about the selected cache server to the client, thus allowing the client to store the file in the selected cache server.

Further, the network interface unit 205 can detect the failure of each cache server and each data server via periodic communication. When a file location information request signal is received from each client, the network interface unit 205 is configured to, if it is determined that the file corresponding to the file location information request signal is stored in any one cache server, transmit information about that cache server to the client that transmitted the request signal, and is configured to, if it is determined that the file corresponding to the file location information request signal is stored only in any one data server, transmit information about that data server to the client that transmitted the request signal.

The data server control unit 204 manages information about data servers, and the data server information includes information about the identifier, address, storage capacity, and remaining space of each data server. The data server information is generated when each data server is registered, and is updated when the capacity information or address of a relevant data server is changed.

Furthermore, if a signal requesting information about a target server in which a duplicate of the stored file is to be written is received from the selected cache server, the data server control unit 204 selects any one first data server in consideration of the remaining storage spaces of the respective data servers based on the previously stored data server information, and transmits information about the selected first data server to the cache server so that the cache server can store a duplicate of the file in the selected first data server.

Furthermore, the data server control unit 204 can select a second data server in which an additional duplicate of the stored file is to be written, and transmit a storage request signal for the additional duplicate to the selected second data server.

Furthermore, when a failure is detected in any one server, the data server control unit 204 can generate a list of duplicates of files stored in the server in which the failure has been detected on the basis of the metadata about the stored files, obtain file information from the generated duplicate list, identify a third data server in which a valid duplicate is stored, among the data servers, select a fourth data server to which files included in the duplicate list are to be duplicated in consideration of the remaining storage spaces of the respective data servers included in the previously stored data server information, and transmit a request signal, requesting the duplication of files included in the duplicate list to the fourth data server, to the third data server.

The data server control unit 204 is configured to, if a file that has not yet been duplicated to the fourth data server is present among the files included in the duplicate list, select a fifth data server to which the file that has not yet been duplicated is to be transmitted, in consideration of the remaining storage spaces of the respective data servers based on the previously stored data server information, and transmit a request signal, causing the file that has not yet been duplicated to be duplicated to the fifth data server, to the third data server via the network interface unit.

Furthermore, the data server control unit 204 may perform control so that, if a file transfer target server information request signal required to transfer files due to the insufficiency of a remaining space is received from any one of the cache servers via the network interface unit, any one fifth data server is selected in consideration of the remaining storage spaces of the respective data servers based on the previously stored data server information, and so that information about the fifth data server is transmitted to the cache server having the insufficient remaining space via the network interface unit, thus allowing the cache server having the insufficient remaining space to transfer files to the fifth data server.

Meanwhile, in accordance with another embodiment, the cache server control unit 203 and the data server control unit 204 may be operated as a single module when cache server information and data server information are managed in an integrated manner depending on an implementation method.

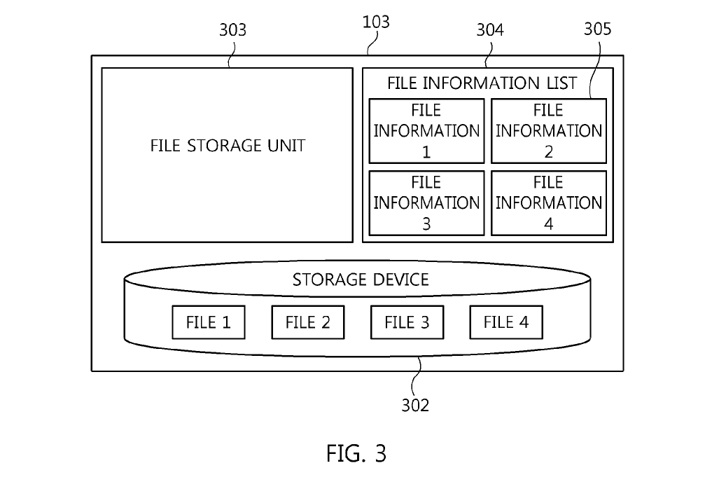

FIG. 3 is a diagram showing the configuration of the cache server according to an embodiment of the present invention.

The cache server 103 includes a file storage unit 303, a file information list 304, and a storage device 302.

It is known that a flash-based storage device 302 such as an SSD mounted on the cache server 103 is efficiently operated in a sequential writing manner such as a log writing manner, due to operations such as wear leveling or garbage collection.

In the system to which the present invention is applied, the cache server 103 maintains the file information list 304 based on the date information of files that have been written so as to indirectly use such effects.

When a file write request is received, the file storage unit 303 adds corresponding file information 305 to the file information list 304, and stores the actual (source) file in the high-speed storage device 302.

The file information list 304 can be implemented as a list or a queue, and the most recently written file information 305 is located at the last location. When the file storage unit 303 continuously monitors the space of the high-speed storage device 302, and the capacity of the remaining storage space is equal to or less than a threshold, the file storage unit 303 selects the oldest files that had been previously stored according to the storage date from the file information list 304, and transfers the selected files to the data server, thus always maintaining the capacity of the remaining storage space at a level greater than the threshold.

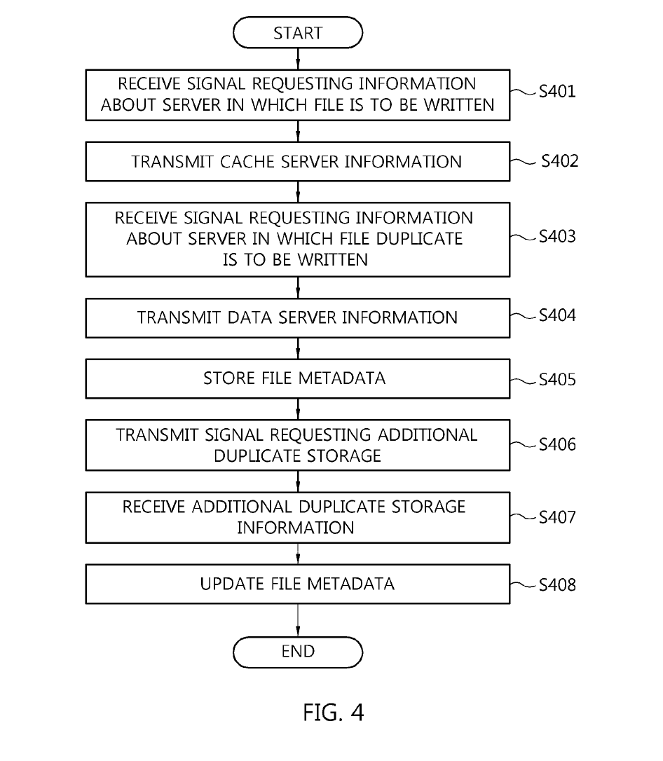

FIG. 4 is a flowchart showing the flow of a file management method using the metadata server according to an embodiment of the present invention.

First, when a signal requesting information about a target server in which a file is to be written is received from a client at step S401, the metadata server selects any one cache server in consideration of the remaining storage spaces of the respective cache servers based on the previously stored cache server information, and transmits information about the selected cache server to the client, thus allowing the client to store the file in the selected cache server at step S402.

Next, when a signal requesting information about a target server in which a duplicate of the stored file is to be written is received from the selected cache server at step S403, the metadata server selects any one first data server in consideration of the remaining storage spaces of the respective data servers based on the previously stored data server information, and transmits information about the selected first data server to the cache server, thus allowing the cache server to store the duplicate of the file in the selected first data server at step S404.

Thereafter, the metadata server receives information about the storage of the file and the duplicate of the file from the selected cache server and the selected first data server, respectively, and then stores the file metadata at step S405.

Next, the metadata server can select a second data server in which an additional duplicate of the stored file is to be written, and transmits a request signal for the storage of the additional duplicate to the selected second data server at step S406.

Thereafter, when a storage completion signal for the additional duplicate is received at step S407, the metadata server updates the stored file metadata at step S408.

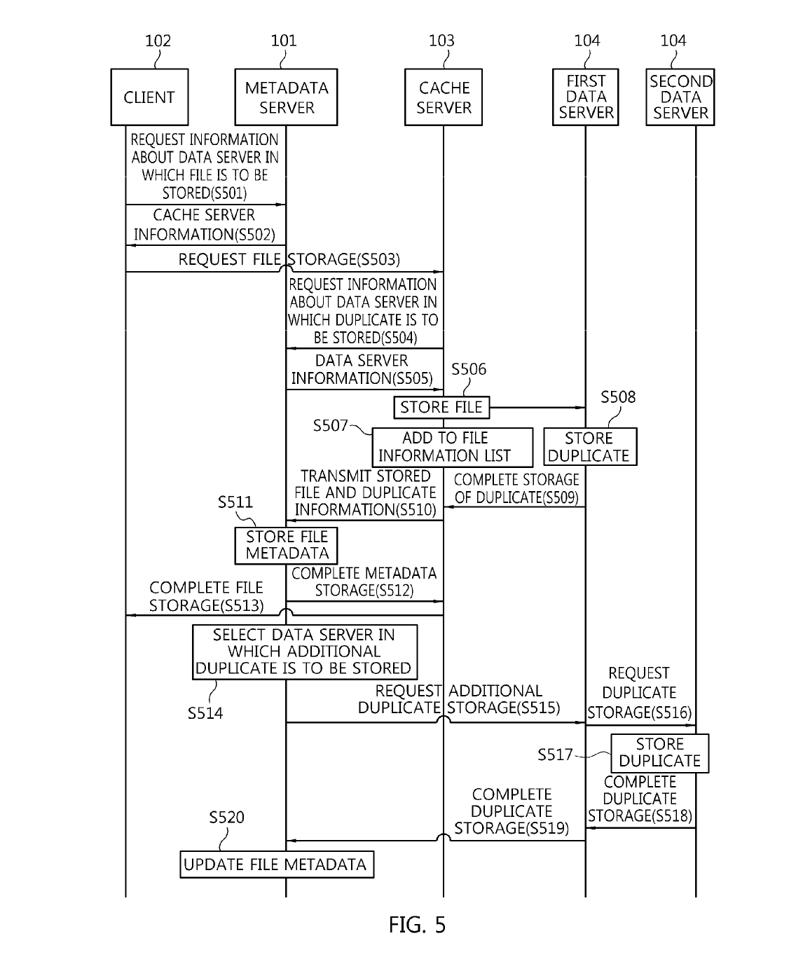

FIG. 5 is a flowchart showing in detail the file management method of FIG. 4.

The hybrid storage system can store a file and can generate a duplicate of the file so as to provide availability via the process of FIG. 5.

The client 102 requests information about a server in which a file is to be written from the metadata server 101 so as to write the file at step S501.

The metadata server 101 selects any one of registered cache servers 103 on the basis of selection criteria such as the sizes of the remaining storage spaces by searching for cache server information, and transmits information about the selected cache server to the client at step S502.

The client 102 requests the received cache server to write the file at step S503.

The cache server 103 that received the file writing request requests the metadata server 101 to obtain information about a data server in which the duplicate is to be stored in real time upon storing the file, in order to obtain the data server information, at step S504.

The metadata server 101 selects any one of the registered data servers 104 based on the criteria used to select the data server similarly to the selection of the cache server, and transmits information about the selected data server to the cache server 103 at step S505.

The cache server 103 stores an actual (source) file at step S506, and also requests the first data server 104 to store a duplicate of the file by transmitting contents of the stored file in real time to the first data server 104.

The cache server 103 completes the storage of the file by adding information about the stored file to a file information list at step S507. After the first data server 104 has completed the storage of the duplicate at step S508, when the first data server 104 sends a message indicative of the completion of the storage of the duplicate at step S509, the cache server 103 notifies the metadata server 101 that the storage of the source file and the duplicate of the file has been completed at step S510.

The metadata server 101 stores metadata about the stored file at step S511, and next notifies the cache server 103 that the storage of the metadata has been successfully completed at step S512.

The cache server 103 verifies that the storage of the metadata has been completed, and notifies the client 102 of the completion of the storage of the file at step S513.

The metadata server 101 selects another data server in which an additional duplicate of the newly stored file is to be stored so as to maintain three duplicates required to provide availability at step S515, and requests the first data server 104 in which the duplicate was already stored to store the additional duplicate at step S515.

After receiving the additional duplicate storage request, the first data server 104 transmits the corresponding duplicate to another second data server 104 so that the duplicate is stored in the second data server 104 at step S516.

The second data server 104 stores the received duplicate at step S517, and transfers the completion of the storage of the duplicate to the first data server 104 at step S518. The first data server 104 transfers the completion of the storage of the duplicate to the metadata server 101, thus terminating the storage of the duplicate at step S519.

After receiving a duplicate storage completion message from the first data server 104, the metadata server 101 updates the metadata by adding information about the new duplicate to the metadata information about the corresponding file at step S520.

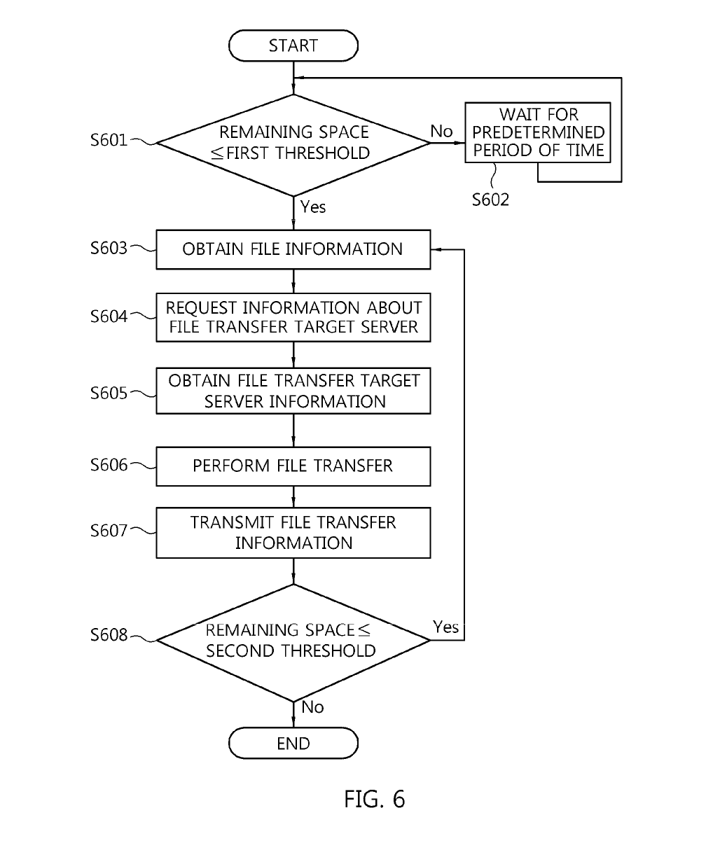

FIG. 6 is a flowchart showing the flow of a file management method using the cache server according to an embodiment of the present invention.

In detail, FIG. 6 is a flowchart showing the transfer of a file from a cache server to a data server in the hybrid storage system. Since the cache server is used as a file write cache for the hybrid storage system, it must maintain a remaining space required to process a new file writing request received from a client.

For this operation, the cache server maintains two thresholds.

A first threshold is the size of a minimum remaining space that must be maintained by the cache server. When the size of the remaining space is equal to or less than the first threshold, the transfer of the file is performed in the background.

A second threshold is a value used when a stored file is transferred to a data server so as to ensure the remaining space in the cache server. Until the remaining space greater than the second threshold is ensured, the transfer of a file is performed in the background.

A file transfer procedure related to the above process will be described below. The cache server periodically monitors the size of a remaining space and then determines whether the size of the remaining space is equal to or less than the first threshold at step S601. If the size of the remaining space is greater than the first threshold, the cache server waits for a preset period of time at step S602, and thereafter compares again the size of the remaining space with the first threshold.

If the size of the remaining space is equal to or less than the first threshold, the file transfer procedure is performed.

For this operation, information about the oldest file, stored for the longest time, is obtained from a file information list managed by the cache server at step S603.

The cache server requests information about a target data server, to which the file is to be transferred, from the metadata server so as to transfer the corresponding file to the data server at step S604.

Next, the cache server obtains information about the transfer target data server, which has been selected by and received from the metadata server based on criteria for the selection of a data server to which the file is to be transferred, at step S605, and performs the transfer of the file by transmitting the file to the data server at step S606.

When a signal indicating that the storage of the file received from the data server has been completed is received, the cache server transmits information about the transferred file to the metadata server at step S607, and the metadata server updates metadata information about the transferred file.

The cache server completes the transfer of the file and compares the size of the remaining space with the second threshold at step S608. If the size of the remaining space is equal to or less than the second threshold, the procedure starting from the file information obtainment step S603 to additionally transfer files is repeated so that the remaining space can be ensured; otherwise, the file transfer procedure is terminated, and the monitoring of the remaining space is performed again.

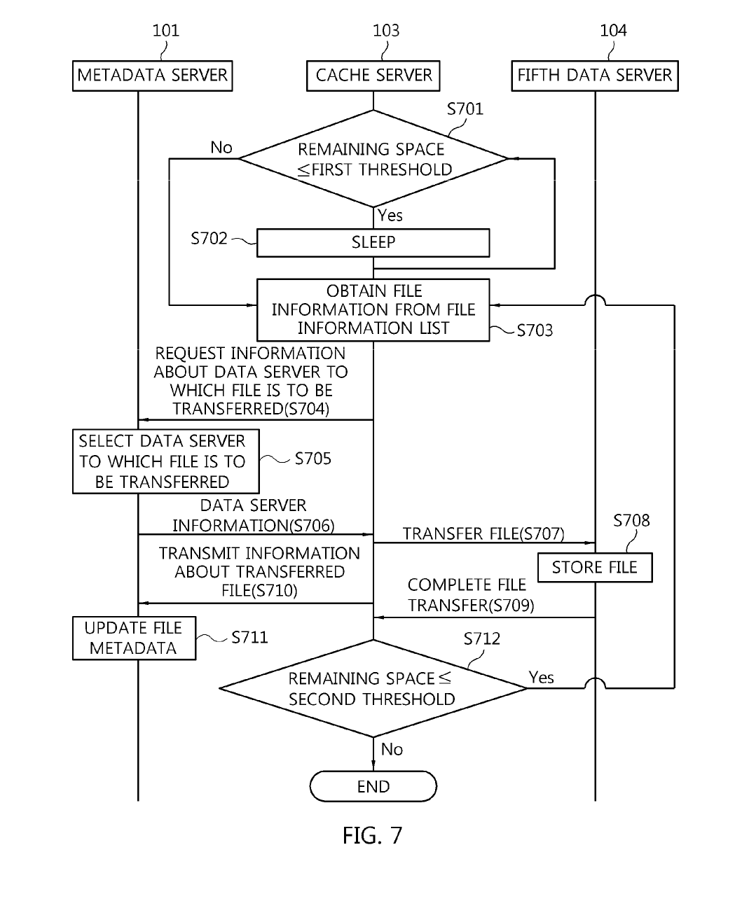

FIG. 7 is a flowchart showing in detail the file management method of FIG. 6.

In detail, FIG. 7 is a diagram showing the file management method for ensuring the remaining space of the file cache server shown in FIG. 6 from the standpoint of the hybrid storage system.

The cache server 103 periodically monitors the size of the remaining space and determines whether the size of the remaining space is equal to or less than the first threshold at step S701.

If the size of the remaining space is greater than the first threshold, the cache server 103 sleeps for a given period of time, and thereafter compares again the size of the remaining space with the first threshold at step S702. If the size of the remaining space is equal to or less than the first threshold, a file transfer procedure is performed.

For this operation, information about the oldest file that has been stored for the longest time is obtained from a file information list managed by the cache server 103 at step S703.

The cache server 103 requests information about a target data server to which the file is to be transferred from the metadata server 101 so as to transfer the corresponding file to the data server at step S704.

The metadata server 101 selects a fifth data server 104 as the target data server based on the criteria used to select the target data server at step S705, and transfers information about the corresponding server to the cache server at step S706.

The cache server 103 transfers the file to the fifth data server 104 based on the received data server information at step S707. The fifth data server 104 stores the received file at step S708, and notifies the cache server 103 of the completion of the storage after the file has been stored at step S709.

The cache server 103 transmits information about the transferred file to the metadata server 101 at step S710, and the metadata server 101 updates metadata information about the transferred file at step S711. The cache server 103 completes file transfer and then compares the size of the remaining space with the second threshold at step S712. If the size of the remaining space is equal to or less than the second threshold, the above procedure is repeated to additionally transfer files so that the remaining space can be ensured; otherwise, the file transfer procedure is terminated, and the monitoring of the remaining space is performed again.

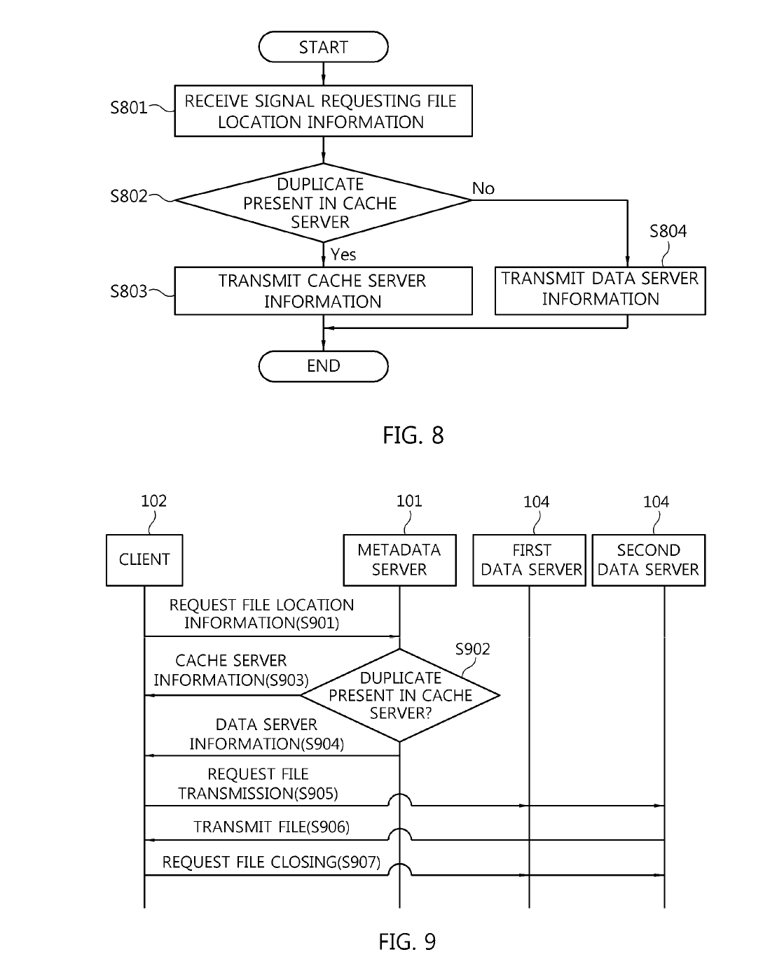

FIG. 8 is a flowchart showing the flow of a file search method using the metadata server according to an embodiment of the present invention.

In accordance with an embodiment, when a file location information request signal is received at step S801, the metadata server determines whether a duplicate of the file corresponding to the request signal is present in the cache server at step S802.

Further, if it is determined at step S802 that the duplicate is present in the cache server, the read speed of the file written in the cache server is higher than the read speed of the file written in the data server, so that information about the cache server in which the file is present is transmitted to the client at step S803.

In contrast, if it is determined at step S802 that a duplicate is not present in the cache server and is present only in the data server, information about the data server in which the file is present is transmitted to the client at step S804.

FIG. 9 is a flowchart showing in detail the file search method of FIG. 8.

Since a file is present in the cache server of the hybrid storage system before a file transfer procedure is performed to ensure a sufficient amount of remaining space, read performance can be improved by obtaining the file from the cache server.

The file read procedure for this operation will be described below. First, the client 102 transmits information about a file desired to be read to the metadata server 101, and requests information about a server in which the corresponding file is stored from the metadata server 101 at step S901.

The metadata server 101 determines whether the file is present in the cache server by searching for metadata information about the file. If the file is present in the cache server, the metadata server 101 transmits information about the cache server to the client 102 at step S903; otherwise the metadata server 101 selects one from among the data servers 104 storing the duplicate of the file, and transmits information about the selected data server to the client 102 at step S904.

The client 102 sends a file transmission request to the cache server or the data server, the information of which has been received, at step S905.

The cache server or the data server transmits the file to the client at step S906, and the client 102 performs a file task and sends a file closing request to the corresponding server so as to terminate the file task at step S907.

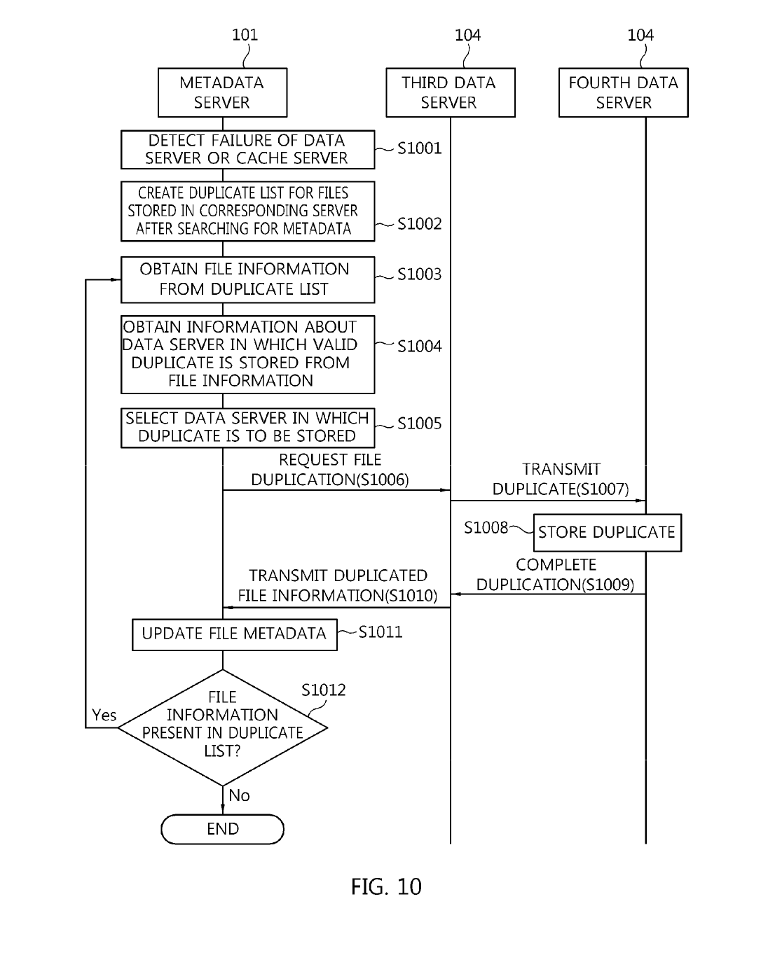

FIG. 10 is a flowchart showing the flow of a file duplication method using the metadata server according to an embodiment of the present invention.

The hybrid storage system can maintain three duplicates so as to provide availability so that a file service is possible by means of different duplicates even if a server storing a file has failed. For this, the hybrid storage system performs a duplicate generation procedure required to maintain the number of duplicates of the file stored in a corresponding server when a failure occurs in a cache server or a data server.

A detailed process for this function will be described in detail. First, the metadata server 101 is notified of information about the status of the corresponding server via periodic communication with each cache server and each data server. If the metadata server 101 does not receive notification of status information from the corresponding server for a preset period of time, the metadata server 101 determines that the corresponding server has failed at step S1001.

If the failure of the server has been detected, the metadata server 101 searches for file information so as to maintain the three duplicates required to provide availability, and then searches for files stored in the failed server, and creates a duplicate list for the files to be duplicated at step S1002.

That is, when a failure is detected in any one server, the metadata server 101 may create a duplicate list for the files stored in the server in which the failure has been detected, on the basis of file metadata stored in the metadata server.

The metadata server 101 obtains information about files to be duplicated from the duplicate list at step S1003, and searches for information about a data server 101 in which a valid duplicate of a corresponding file is stored at step S1004.

Thereafter, the metadata server selects another fourth data server 104 in which the duplicate is to be stored at step S1005, and sends a duplication request to the third data server 104 in which the duplicate is stored at step S1006.

The third data server requests the duplication of the requested file by transmitting the duplicate of the file to the fourth data server at step S1007. The fourth data server stores the duplicate at step S1008, and thereafter notifies the third data server of the completion of the duplication at step S1009.

The third data server notifies the metadata server 101 that the duplicate is stored in the fourth data server at step S1010, and the metadata server 101 updates the metadata about the file at step S1011.

The metadata server 101 determines whether the duplication task has been completed by inspecting the duplicate list at step S1012, and repeats the above process if any file to be duplicated remains.

That is, if any file that has not yet been duplicated to the fourth data server is present among the files included in the duplicate list, the metadata server can select a fifth data server to which the file that has not yet been duplicated is to be transmitted in consideration of the remaining storage spaces of the respective data servers, based on the previously stored data server information, and can transmit to the third data server a request signal causing the file that has not yet been duplicated to be duplicated to the fifth data server.

According to the configuration of the present invention, there is an advantage in that the write performance of a file can be improved by utilizing a data server, implemented as a high-speed storage device such as an SSD, as a data cache server, and availability can be provided by maintaining three file duplicates by means of real-time duplication and delayed duplication, in a hybrid storage system in which a plurality of data servers including storage devices having different characteristics are connected to one another over a network.

Although the preferred embodiments of the present invention have been disclosed for illustrative purposes, those skilled in the art will appreciate that the present invention is not limited by the above-described specific embodiments and various modifications are possible, without departing from the scope and spirit of the invention as disclosed in the accompanying claims. These modifications should not be understood separately from the technical spirit or prospect of the present invention.

What is claimed is:

1. A file management method using a metadata server of a hybrid storage management system, comprising:
selecting any one cache server in consideration of storage spaces of respective cache servers based on previously stored cache server information when a request for information about a target server in which a file is to be written is received from a client;
transmitting information about the selected cache server to the client so that the client stores the file in the selected cache server;
selecting any one first data server in consideration of storage spaces of respective data servers based on previously stored data server information when a signal requesting information about a target server in which a duplicate of the stored file is to be written is received from the selected cache server;
transmitting information about the selected first data server to the cache server so that the cache server stores a duplicate of the file in the selected first data server; and
receiving information about storage of the file and the duplicate from the selected cache server and the selected first data server, and then storing file metadata.

2. The file management method of claim 1, further comprising:
selecting a second data server in which an additional duplicate of the stored file is to be written;
sending a storage request for the additional duplicate to the selected second data server; and
when a storage completion signal for the additional duplicate is received, updating the stored file metadata.

3. The file management method of claim 1, wherein:
each cache server is implemented as a Solid State Drive (SSD), and
each data server is implemented as a Hard Disk Drive (HDD).

4. The file management method of claim 1, further comprising:
detecting a failure of each cache server and each data server via periodic communication;
if a failure has been detected in any one server, creating a duplicate list for files stored in the server in which the failure has been detected, based on the stored file metadata;
obtaining file information from the created duplicate list, and identifying a third data server in which a valid duplicate is stored among the data servers;
selecting a fourth data server to which the files included in the duplicate list are to be duplicated in consideration of storage spaces of the respective data servers included in the previously stored data server information;
transmitting a request to duplicate the files included in the duplicate list to the fourth data server to the third data server; and
if a duplication completion signal has been received from the third data server, updating the stored file metadata.

5. The file management method of claim 4, further comprising:
if a file that has not yet been duplicated to the fourth data server is present among the files included in the duplicate list, selecting a fifth data server to which the file that has not yet been duplicated is to be transmitted in consideration of remaining storage spaces of the respective data servers based on the previously stored data server information; and
transmitting to the third data server a request to duplicate the file that has not yet been duplicated to the fifth data server.

6. The file management method of claim 1, further comprising:
when a file location information request is received from the client, if it is determined that a file corresponding to the file location information request is stored in any one cache server, transmitting information about that cache server to the client that transmitted the request; and
if it is determined that the file corresponding to the file location information request is stored in any one data server, transmitting information about that data server to the client that transmitted the request.

7. The file management method of claim 1, further comprising:
when a file transfer target server information request required to transfer a file is received from any one of the cache servers due to insufficiency of a remaining space, selecting any one fifth data server in consideration of storage spaces of the respective data servers based on the previously stored data server information; and
transmitting information about the fifth data server to the cache server having an insufficient remaining space, thus allowing the cache server having the insufficient remaining space to transfer the file to the fifth data server.

8. The file management method of claim 7, further comprising:
if the transfer of the file is completed by the cache server having the insufficient remaining space and information about the transfer of the file is received, updating the stored file metadata.

9. A metadata server for a hybrid storage management system, comprising:
a cache server control unit for, when a request for information about a target server in which a file is to be written is received from a client, selecting any one cache server in consideration of storage spaces of respective cache servers based on previously stored cache server information;
a network interface unit for transmitting information about the selected cache server to the client, thus allowing the client to store the file in the selected cache server;
a data server control unit for, when a request for information about a target server in which a duplicate of the stored file is to be written is received from the selected cache server, selecting any one first data server in consideration of remaining storage spaces of respective data servers based on previously stored data server information, and transmitting information about the selected first data server to the cache server so that the cache server stores a duplicate of the file in the selected first data server; and
a metadata control unit for receiving information about storage of the file and the duplicate from the selected cache server and the selected first data server, and then storing file metadata.

10. The metadata server of claim 9, wherein:
the data server control unit is configured to select a second data server in which an additional duplicate of the stored file is to be written, and transmit a storage request for the additional duplicate to the selected second data server, and
the metadata control unit is configured to, when a storage completion signal for the additional duplicate is received, update the stored file metadata.

11. The metadata server of claim 9, wherein:
each cache server is implemented as a Solid State Drive (SSD) device, and
each data server is implemented as a Hard Disk Drive (HDD).

12. The metadata server of claim 9, wherein:
the network interface unit detects a failure of each cache server and each data server via periodic communication,
the data server control unit is configured to, if a failure has been detected in any one server, create a duplicate list for files stored in the server in which the failure has been detected, based on the stored file metadata, obtain file information from the created duplicate list, identify a third data server in which a valid duplicate is stored among the data servers, select a fourth data server to which the files included in the duplicate list are to be duplicated in consideration of storage spaces of the respective data servers included in the previously stored data server information, and transmit a request to duplicate the files included in the duplicate list to the fourth data server to the third data server, and
the metadata control unit is configured to, if a duplication completion signal has been received from the third data server, update the stored file metadata.

13. The metadata server of claim 12, wherein the data server control unit is configured to, if a file that has not yet been duplicated to the fourth data server is present among the files included in the duplicate list, select a fifth data server to which the file that has not yet been duplicated is to be transmitted in consideration of storage spaces of the respective data servers based on the previously stored data server information, and transmit a request to duplicate the file that has not yet been duplicated to the fifth data server to the third data server via the network interface unit.

14. The metadata server of claim 9, wherein the network interface unit is configured to, when a file location information request is received from the client, if it is determined that a file corresponding to the file location information request is stored in any one cache server, transmit information about that cache server to the client that transmitted the request, and if it is determined that the file corresponding to the file location information request is stored in any one data server, transmit information about that data server to the client that transmitted the request.

15. The metadata server of claim 9, wherein the data server control unit is configured to, when a file transfer target server information request required to transfer a file is received from any one of the cache servers due to insufficiency of a remaining space via the network interface unit, select any one fifth data server in consideration of remaining storage spaces of the respective data servers based on the previously stored data server information, transmit information about the fifth data server to the cache server having an insufficient remaining space via the network interface unit, and then allow the cache server having the insufficient remaining space to transfer the file to the fifth data server.

16. The metadata server of claim 9, wherein the metadata control unit is configured to, if the transfer of the file is completed by the cache server having the insufficient remaining space and information about the transfer of the file is received via the network interface unit, update the stored file metadata.
